(19) United States
(12) Patent Application Publication
(10) Pub. No.: US 2005/0237699 A1
(43) Pub. Date: Oct. 27, 2005

(54) Multi-screen mobile computing system

(76) Inventor: David Carroll, Green Valley, AZ (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/111,399

(22) Filed: Apr. 21, 2005

Related U.S. Application Data
(60) Provisional application No. 60/564,632, filed on Apr. 21, 2004.

(51) Int. Cl. H02B 1/00

(52) U.S. Cl. 361/600

(57) ABSTRACT

A hand-held, mobile computing system for displaying content. The system includes a first display screen, a second display screen, a microprocessor, and a housing. The first and second display screens are movable relative to one another. The microprocessor is communicatively linked to the first and second display screens. Further, the microprocessor is adapted to prompt display of desired content on the first and second display screens such that content displayed on the first display screen correlates with content displayed on the second display screen, resulting in an enhanced content display. The housing maintains the first microprocessor, is physically connected to at least one of the first and second display screens, and is sized to fit within a user's hands.

### CROSS-REFERENCE TO RELATED APPLICATIONS

The subject matter of this patent application is related to the subject matter of U.S. Provisional Patent Application Ser. No. 60/564,632, filed Apr. 21, 2004 and entitled “Mobile Computing Devices” (Attorney Docket No. P374.104.101), priority to which is claimed under 35 U.S.C. §119(e) and an entirety of which is incorporated herein by reference.

### BACKGROUND

The present invention relates to display of content with one or more hand-held, mobile computing devices. More particularly, it relates to a hand-held mobile computing system for displaying content on multiple screens.

Personal computers are virtually a commonplace in today's society. Continued advancement in the technology and manufacturing of various components associated with the personal computer (e.g., processor, memory, display, etc.) have greatly enhanced the operational capabilities of personal computers. For example, while desktop personal computers continue to be widely used, component technology advancements in combination with development of viable battery power sources has resulted in highly popular laptop personal computers. The transition of consumer preference from desktop personal computers to laptop personal computers is a reflection of an overall demand for portable or mobile electronic devices. That is to say, consumers desire the ability to conveniently transport and use their personal computers at various locations.

While laptop computers represent a marked improvement, in terms of mobility, over conventional desktop personal computers, certain consumer desires remain unfulfilled. More particularly, consumers have come to demand even smaller-sized (as compared to a conventional laptop personal computer) electronic devices that are thus inherently more mobile or portable. To this end, personal digital assistants (PDAs), digital cameras, and mobile phones are now widely available and highly popular. Even more recently, attempts have been made to develop a more portable personal computer sized to be held and operated with only the user's hand(s). While the continued evolution of technology will undoubtedly result in highly viable, hand-held, mobile, personal computers (or computing devices), certain operational limitations have and will arise.

One particular limitation inherent to the existing and contemplated hand-held, mobile computing devices is the size of the display screen. In order to be truly mobile, the display screen associated with the hand-held, mobile computing device inherently must be relatively small (especially as compared to display screens associated with conventional desktop and laptop computing devices). While the technology associated with these small sized display screens can provide enhanced image quality and contrast, displayed images must either be greatly reduced in size, or only a portion of a particular image can be shown at any one point in time (with the user being required to “scroll” through the image). Further, while microprocessor capabilities continue to dramatically increase, currently available and envisioned hand-held mobile computing devices provide display screen(s) that face (and thus are viewable in) a single direction.

In light of the above, a need exists for an improved hand-held, mobile computing system capable of displaying content on an enlarged display screen area.

### SUMMARY

One aspect of the present invention relates to a hand-held, mobile computing system for displaying content. The system includes a first display screen, a second display screen, a microprocessor, and a housing. The first and second display screens are movable relative to one another. The microprocessor is communicatively linked to the first and second display screens. Further, the microprocessor is adapted to prompt display of desired content on the first and second display screens such that content displayed on the first display screen correlates with content displayed on the second display screen. This, in turn, results in an enhanced display content. Finally, the housing maintains the first microprocessor and is physically connected to at least one of the first and second display screens, and is sized to fit within a user's hands.

In one embodiment, the system consists of at least two hand-held, mobile computing devices each including a housing maintaining a display screen and a microprocessor. The housings are adapted to establish a communicative link between the corresponding microprocessors, such as a wireless connection. In this regard, at least one of the microprocessors is adapted to prompt a correlated display on the display screens when the computing devices are communicatively linked. With this configuration, then, the system promotes a shared display mode in which the display screens of two or more computing devices are connected and can generate a relatively continuous displayed image. In another embodiment, the first and second display screens are physically connected to one another via corresponding frame portions provided by the housing. More particularly, the frame portions are movably attached to one another, providing a first, closed state in which the display screens are aligned with one another and at least one display screen in partially or fully covered, and a second, open state in which the display screens are exposed.

### BRIEF DESCRIPTION OF THE DRAWINGS

FIG. 1A is a block diagram of a mobile computing system in accordance with the present invention;

FIG. 1B is a block diagram of an alternative embodiment mobile computing system in accordance with the present invention;

FIG. 2A is a perspective view of a mobile computing system in accordance with the present invention in a closed state;

FIG. 2B is a perspective view of the mobile computing system of FIG. 2A in an opened state;

FIG. 3 is a simplified, side view of the mobile computing system of FIG. 2B during use;

FIG. 4 is a front perspective view of an alternative embodiment mobile computing system in accordance with the present invention;

FIG. 5A is a front perspective view of another alternative embodiment mobile computing system in accordance with the present invention in a closed state;

FIG. 5B is a side perspective view of the mobile computing system of FIG. 5A in an opened state;

FIG. 6 is a front view of another alternative embodiment mobile computing system in accordance with the present invention; and

FIG. 7 is a front perspective view of another alternative embodiment mobile computing system in accordance with the present invention.

### DETAILED DESCRIPTION

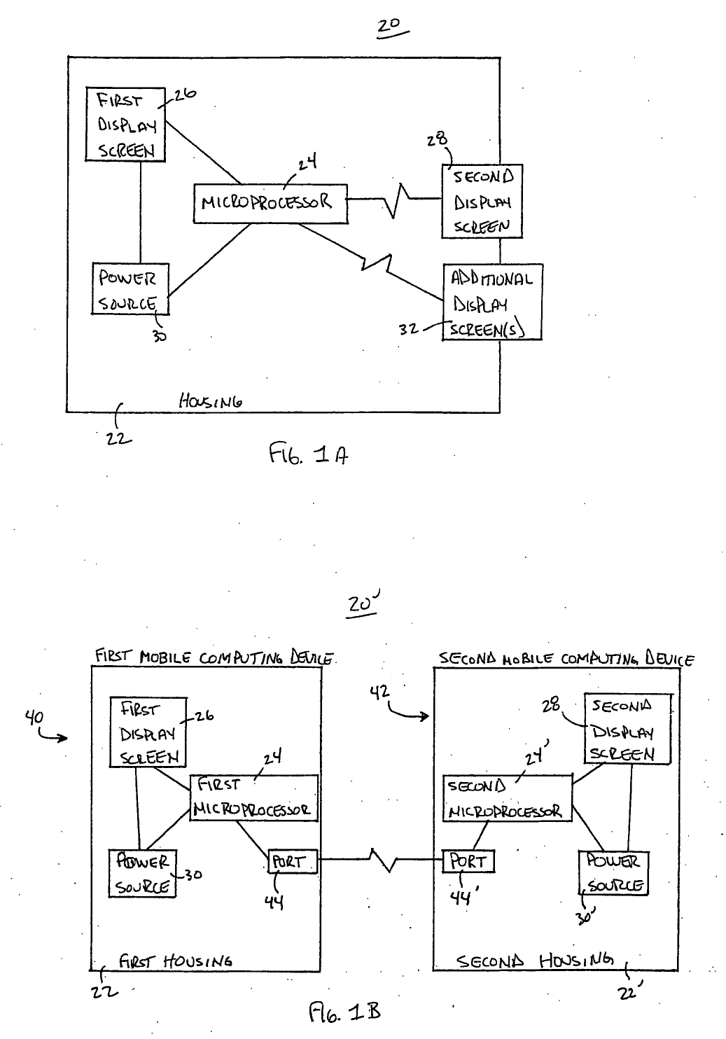

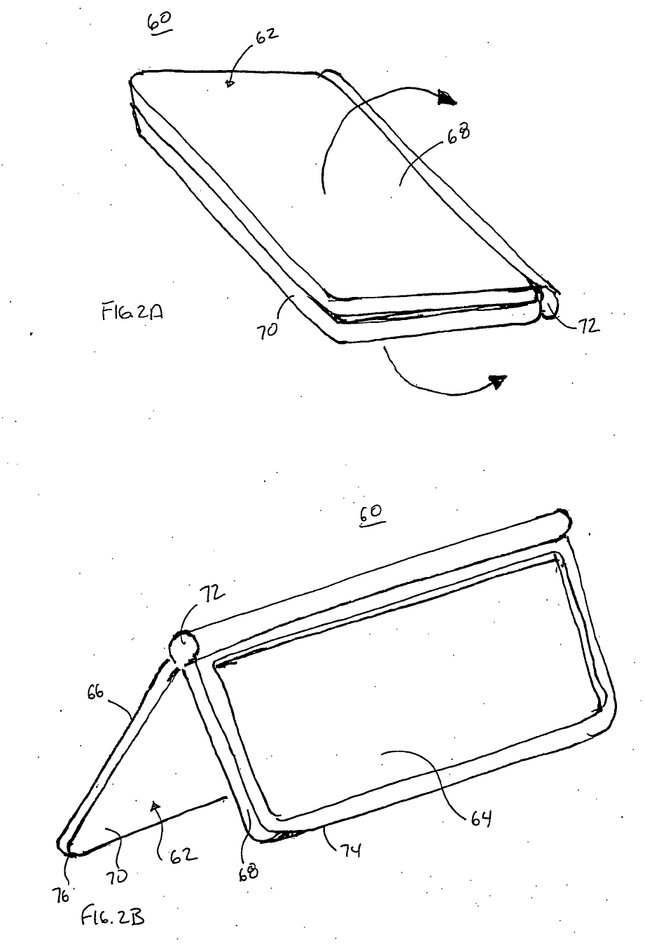

One embodiment of a mobile computing system 20 in accordance with the present invention is shown in the block diagram of FIG. 1A. As described in greater detail below, the system 20 can assume a wide variety of forms, and generally includes at least one housing 22, at least one microprocessor 24, a first display screen 26, a second display screen 28 and at least one power source 30. In addition, the system 20 can include one more auxiliary components (not shown) such as operational modules (e.g., word processing, speech recognition, internet browser, etc.), speaker(s), microphone(s), connection port(s), etc. Regardless, at least the microprocessor 24, the first display screen 26, and the power source 30 are maintained by the housing 22, with the microprocessor 24 performing computing operations and controlling display on the display screens 26, 28. In this regard, the second display screen 28 is illustrated in FIG. 1A as being partially maintained by the housing 22. As explained below, this depiction is illustrative of the present invention encompassing systems in which the second display screen 28 (as well as potentially additional display screens 32) is secured to or placed within an assignable proximity the housing 22, as well as systems (described below) in which the second display screen 28 is provided as part of a separate computing device. In either embodiment, the second display screen 28 is movable relative to the first display screen 26 (such as by forming the housing 22 in a manner that allows movement of the display screens 26, 28 relative to one another, or by providing the second display screen 28 as part of a separate housing). Regardless, the second display screen 28 is communicatively linked to the microprocessor 24 (either a permanent electrical connection within the housing 22 or a selective electrical connection when a separate computing device is linked to the microprocessor 24) such that the microprocessor 24 can prompt a correlating display on the first and second display screens 26, 28. Where the system 20 includes the first and second display screens 26, 28 as part of the housing 22, the system 20 itself can constitute a hand-held, mobile computing device.

FIG. 1B better illustrates (in block form) an alternative embodiment system 20′ having first and second hand-held, mobile computing devices 40, 42. The first hand-held, mobile computing device 40 includes the first housing 22, the first microprocessor 24, the first display screen 26, and the power source 30. The second hand-held, mobile computing device 42 includes a similar housing 22′, a second microprocessor 24′, the second display screen 28 and a power source 30′. Each of the housings 22, 22′ are adapted to selectively facilitate a communicative link between the first and second microprocessors 24, 24′ via corresponding ports 44, 44′ (e.g., physical connection between the ports 44, 44′, wireless connection via the ports 44, 44′, etc.). As used throughout this specification, the term “port” is used in a generic sense to represent a feature that facilitates communication between two or more mobile computing devices. Thus, the “port” can by a mechanical/physical connector, wireless connector, etc. When linked, and as described in greater detail below, the microprocessors 24, 24′, either alone or in concert, are adapted to provide a correlating display on the first and second display screens 26, 28. Though not shown, the mobile computing devices 40, 42 can include additional features useful in accordance with the present invention, such as a proximity sensor(s) or strength of a wireless signal sensor(s) as known in the art.

With continued reference to FIGS. 1A and 1B, and in general terms, the system 20 or the mobile computing devices 40, 42 can assume a wide variety of forms that otherwise incorporate a number of different operational features. For example, the system 20 or the mobile computing devices 40, 42 can be or incorporate a mobile phone, a hand-held camera, a personal data assistant, a speech translator, etc. All necessary components and software for performing the desired operations associated with the designated end use is not necessarily shown in FIGS. 1A and 1B, but is/are readily incorporated therein (e.g., input/output ports, lenses, wireless communication modules, etc.). With this in mind, the housing 22, 22′ can assume a variety of forms appropriate for the end use. A size and shape of the housing 22, 22′ is conducive to handling thereof by one or both hands of a user (not shown), such that the housing 22, 22′ has a size generally akin to known hand-held electronic devices. In alternative embodiments described below, the housing 22, 22′ can be configured to selectively “close” and “open” one or both of the display screens 26, 28 (as well as the additional display screen(s) 32 where provided).

The microprocessor 24, 24′ can assume a variety of forms known in the art or in the future created, including, for example Intel® Centrino™ and chips and chip sets (e.g., Efficeon™) from Transmeta Corp., of Santa Clara, Calif., to name but a few. Alternatively, the microprocessor 24, 24′ can be a multicore microprocessor. In most basic form, however, the microprocessor 24, 24′ is capable of performing all end use-specific computing applications, such as operating a personal computer operating system (e.g., Windows Operating System) that can be provided as part of the microprocessor 24, 24′ or via a separate component (not shown) electrically connected to the microprocessor 24, 24′, as well as to prompt the display screens 26, 28 to display content in a correlated fashion via a display driver (not shown) as known in the art. The display driver can be provided as part of the microprocessor 24, 24′ or as a separate module electronically connected to the corresponding microprocessor 24, 24′. As described below, in one embodiment, the microprocessor 24 (and/or, where provided, the second microprocessor 24′) is adapted to display a relatively continuous image “across” the display screens 26, 28, resulting in an enhanced content display. Alternatively or in addition, the microprocessor 24 (and/or, where provided, the second microprocessor 24′) is adapted to prompt the display screens 26, 28 to display related content that, while not necessarily defining a continuous image, is related in a desired manner. The ability to control the display driver to form a continuous image across multiple screens and/or to display different images on two or more screens can be accomplished using coordinated algorithms permitting multiple screen displays.

In alternative embodiments, the system 20, 20′ can include two or more microphones (not shown), with the microprocessor 24 (and/or, where provided, the second microprocessor 24′) being adapted to coordinate audio inputs received at the microphones, such as for noise cancellation. Similarly, in other alternative embodiments, the system 20, 20′ can include two or more speakers (not shown), with the microprocessor 24 (and/or, where provided, the second microprocessor 24′) being adapted to coordinate audio outputs delivered through the speakers, such as for stereo, surround sound, or other sound effects.

The display screens 26, 28 are of a type known in the art or in the future created. The display screens 26, 28 may or may not be identical, are of a relatively small physical size, for example on the order of 2 inches×4 inches, and can incorporate a wide variety of technologies (e.g., pixel size, etc.). Regardless of exact dimensions, the limited size of the display screens 26, 28 renders displaying an entirety of desired content on only one of the display screens 26, 28 difficult. For example, a large image cannot be adequately displayed as a whole on one of the display screens 26 or 28. As described below, the system in accordance with one aspect of the present invention can overcome this deficiency by displaying the image in relatively continuous fashion across the display screen 26, 28.

The power source 30, 30′ is, in one embodiment, a lithium-based, rechargeable battery such as a lithium battery, a lithium ion polymer battery, a lithium sulfur battery, etc. Alternatively, a number of other battery configurations are equally acceptable. Regardless, the power source 30, 30′ is capable of providing long-term power to the various components of the system 20 or the mobile computing devices 40, 42.

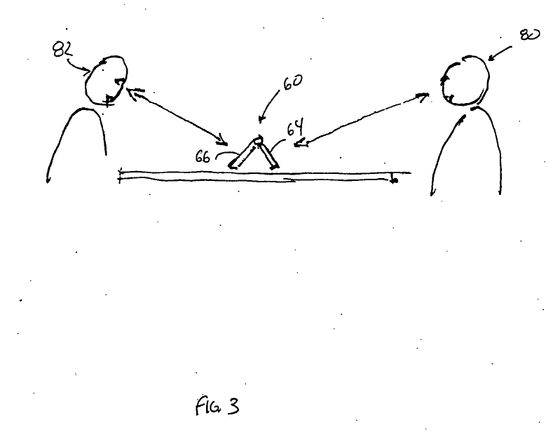

With the general description provided above in mind, FIGS. 2A and 2B illustrate a hand-held, mobile computing system 60 embodiment in accordance with the present invention. The system 60 is configured to be a hand-held, mobile computing device and includes a housing 62, a microprocessor (not shown), a first display screen 64 (best shown in FIG. 2B), a second display screen 66 (referenced generally in FIG. 2B), and a power source (not shown).

The housing 62 is sized to be handled by a user's hand(s) such that the system 60 is mobile or portable, and includes a first frame portion 68, a second frame portion 70, and a connector 72. The first frame portion 68 maintains the first display screen 64, whereas the second frame portion 70 maintains the second display screen 66. The connector 72 establishes a permanent, physical connection between the frame portions 68, 70, whereby the first frame portion 68 is hingedly secured to the second frame portion 70. Thus, the first and second frame portions 68, 70 can pivot relative to one another via the connector 72. The connector 72 can assume a variety of forms, and in one embodiment is a metal or plastic hinge (such as a living hinge).

With the above construction, the housing 62 provides for a first, closed state (FIG. 2A) and a second, opened state (FIG. 2B). In the closed state, the first and second frame portions 68, 70 are pivoted, via the connector 72, toward one another such that the display screens 64, 66 are substantially aligned and face one another. Thus, in the closed state, the display screens 64, 66 are covered (cannot be viewed), with the housing 62 serving to protect the display screens 64, 66 from potential damage. In one embodiment, the microprocessor (not shown) is adapted to automatically power down or implement a “sleep” mode for the display screens 64, 66 when the housing 62 is in the closed state. Along these same lines, the housing 62 can incorporate a closure feature (not shown) that secures the frame portions 68, 70 to one another in the closed state, with the system 60 further including a sensor(s) that signals the microprocessor when the closed state of the housing 62 is sensed.

The housing 62 can be transitioned from the closed state of FIG. 2A to the opened state of FIG. 2B by pivoting the frame portions 68, 70 relative to one another at the connector 72 (represented by arrows in FIG. 2A). In the open state of FIG. 2B, the display screens 64, 66 are exposed (i.e., can be viewed by a user(s)) and face in different directions. In one embodiment, the housing 62 incorporates a locking feature (not shown) that locks or maintains the frame portions 68, 70 to the orientations shown in FIG. 2B in the opened state. For example, one or both of the frame portions 68, 70 can incorporate a stop surface that prevents overt, pivoting movement of the frame portions 68, 70 relative to one another beyond the orientation of FIG. 2B. In the opened state, the frame portions 68, 70 combine to define a triangle-like shape, with the connector 72 being the top or “apex” of the triangle. With this configuration, bottoms 74, 76, respectively, of the frame portions 68, 70 can rest on a surface (e.g., table top), with the display screens 64, 66 being appropriately oriented at a desired viewing angle. In one embodiment, the connector 72 includes a bias device (e.g., a spring or spring-like force) that supports the frame portions 68, 70 in the open state such that the housing 62 can be placed on a table top or other surface and not collapse.

Use of the system 60 (with the housing 62 in the opened state) is illustrated in FIG. 3. More particularly, a first user 80 views the first display screen 64 (referenced generally in FIG. 3) while a second user 82 simultaneously views the second display screen 66 (referenced generally in FIG. 3). With this approach, the microprocessor (not shown) can be adapted to prompt identical content to be simultaneously displayed on the display screens 64, 66. Alternatively or in addition, the microprocessor can be adapted to prompt different yet related content to be displayed on the first display screen 64 relative to the displayed content of the second display screen 66. For example, in one alternative embodiment, the system 60 further includes a translation module (not shown) capable of translating words in to two or more languages. This may be a standalone feature, or combined with a speech recognition module whereby words spoken by the first user 80 are recognized and then translated to a different language that is displayed textually to the second user 82, and vice-versa. Regardless, with this alternative embodiment, the microprocessor can be adapted such that content displayed on the first display screen 64 is text or information in a first language, and content displayed on the second display screen 66 is the same text or information but in a second, different language. With this configuration, the first user 80 can speak in a first language (such as towards a microphone (not shown) provided by the system 60) and review the speech-converted text presented in the first language on the first display screen 64 while the second user 82 nearly simultaneously reads the speech-converted words of the first user 80 on the second display screen 66, but in a different language understood by the second user 82. Alternatively, the first and second users 80, 82 can simultaneously review a standalone document displayed to each user in a desired language. Further, where the microprocessor is a multicore microprocessor, the system 60 can operate to perform a two-way language translation operation. In an alternative embodiment, the system 60 can further include first and second speakers (not shown) maintained by the first and second frame portions 68, 70, respectively; in the opened state, the microprocessor is adapted to coordinate audio output delivered through the speakers.

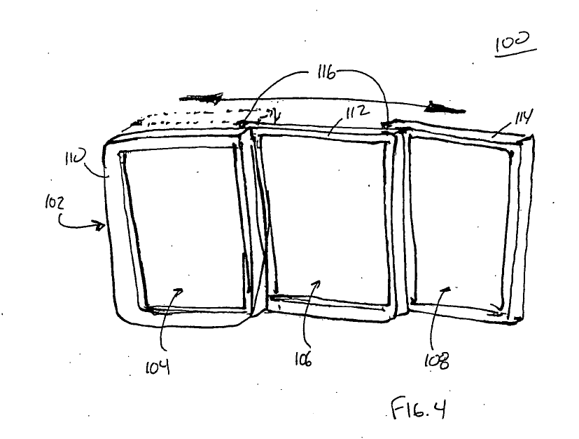

An alternative embodiment hand-held, mobile computing system 100 is shown in FIG. 4. As with the embodiment of FIGS. 2A and 2B, the system 100 is configured to be a hand-held, mobile computing device and includes a housing 102, a microprocessor (not shown), a first display screen 104, a second display screen 106, a third display screen 108, and a power source (not shown).

The housing 102 is sized to be handled by a user's hand(s) such that the system 100 is mobile or portable, and includes a first frame portion 110, a second frame portion 112, a third frame portion 114, and a connector 116 (referenced generally). The first frame portion 110 maintains the first display screen 104; the second frame portion 112 maintains the second display screen 106; and the third frame portion 114 maintains the third display screen 108. The connector 116 establishes a permanent, physical connection between the frame portions 110-114, whereby the frame portions 110-114 are slidable relative to one another. For example, in one embodiment, a segment of the second frame portion 112 is slidably connected within a corresponding feature (e.g., a slot (not shown)) formed in a back of the first frame portion 110, whereas the third fame portion 114 is similarly slidably connected to the second frame portion 112. Alternatively, other configurations, such as a rail system, gear system, Velcro, magnetic, etc., can be employed.

With the above construction, the housing 102 provides for a first, closed state (shown with dashed lines in FIG. 4) and a second, opened state (shown in FIG. 4). In the closed state, the frames portions 110-114 are moved together, such that the display screens 104-108 are substantially aligned, with at least the second and third display screens 106, 108 being covered. In one embodiment, the system 100 can be operated in the closed state, with only the first display screen 104 being prompted by the microprocessor (not shown) to display desired content. To this end, the system 100 can be further adapted such that the microprocessor recognizes when the housing 102 is in the closed state (e.g., one or more sensors can be incorporated into one or more of the frame portions 110-114 that “detect” when the frame portions 110-114 are aligned; a user input can be provided whereby the user indicates whether one or more than one of the display screens 104, 106 and/or 108 should be powered and activated; etc.) and operates to display content on only the first display screen 104.

The system 100 is transitioned to the opened state by sliding the frame portions 110-114 relative to one another (represented by arrows in FIG. 4) such that display screens 104-108 are transversely displaced from one another, with each of the display screens 104-108 being at least partially, preferably entirely, exposed and thus viewable by a user (not shown). In one embodiment, the housing 102 incorporates features (not shown) that selectively “lock” the frame portions 110-114 relative to one another in one or both of the closed and opened states. Regardless, in the opened state, each of the display screens 104-108 are prompted by the microprocessor (not shown) to display correlated content. For example, in one embodiment, the microprocessor causes the display screens 104-108 to display a relatively continuous image/content across the display screens (e.g., an image can be divided into three segments, with the first segment being displayed on the first display screen 104, the second segment being displayed on the second display screen 106, and the third segment being displayed on the third display screen 108). Alternatively or in addition, the display screens 104-106 can be prompted to display different, yet related content (e.g., three pages of a document). With either approach, the system 100 provides a greatly enhanced, viewable content, effectively tripling the viewable area as compared to a single screen hand-held, mobile computing device. To this end, the system 100 can further include one or more additional display screens/frame portions; conversely, the third display screen 108/frame portion 114 can be eliminated.

In other embodiments, each of the frame portions 110-114 further maintain a microphone (not shown), respectively, each electronically connected to the microprocessor (not shown). In the opened state, each of the microphones are available to received audio input from a user(s). Under these circumstances, and similar to the coordinated display described above, the microprocessor operates to coordinate the audio inputs received by the microphones (for example to perform a noise cancellation operation). In a related alternative embodiment, each of the frame portions 110-114 further maintains a speaker (not shown), respectively, each electronically connected to the microprocessor. In the opened state, each of the speakers are available to deliver an audio output to a user(s). The microprocessor operates to coordinate the audio outputs delivered through the speakers (for example to create an enhanced audio presentation such as stereo or surround sound).

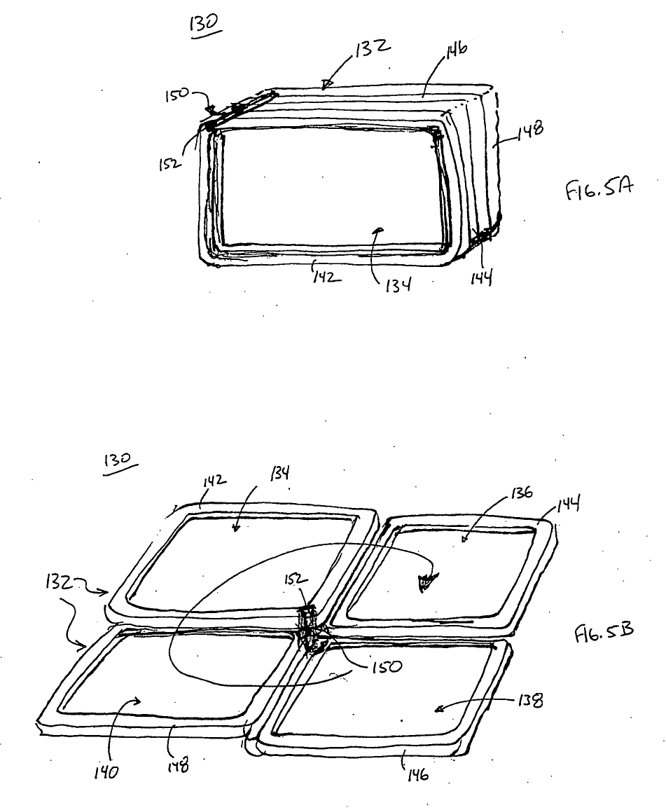

Another alternative embodiment hand-held, mobile computing system 130 is shown in FIGS. 5A and 5B. As with the embodiments of FIGS. 2A, 2B, and 4, the system 130 is configured to be a hand-held, mobile computing device and includes a housing 132, a microprocessor (not shown), a first display screen 134, a second display screen 136, a third display screen 138, a fourth display screen 140, and a power source (not shown).

The housing 132 is sized to be handled by a user's hand(s) such that the system 130 is mobile or portable, and includes a first frame portion 142, a second frame portion 144, a third frame portion 146, a fourth frame portion 148, and a connector 150 (referenced generally). The first frame portion 142 maintains the first display screen 134; the second frame portion 144 maintains the second display screen 136; the third frame portion 146 maintains the third display screen 138; and the fourth frame portion 148 maintains the fourth display screen 140. The connector 150 establishes a permanent, physical connection between the frame portions 142-148, whereby the frame portions 142-148 are rotatable relative to one another. For example, in one embodiment, the connector 150 includes a pin 152 connected to a corresponding perimeter area or corner of each of the frame portions 142-148, as best shown in FIG. 5B. The pin 152 secures the frame portions 142-148 in a manner allowing the frame portions 142-148 to freely rotate relative to one another about the pin 152.

With the above construction, the housing 132 provides a first, closed state (FIG. 5A) and a second, opened state (FIG. 5B). In the closed state of FIG. 5A, the frame portions 142-148 are rotated to a commonly aligned arrangement such that the display screens 134-140 are also substantially aligned. At least the second, third and fourth display screens 136-140 are thus “covered” in the closed state. Further, the system 130 defines a highly compact form factor in the closed state, such that the system 130 can easily be transported by the user (not shown), such as in the user's pocket, purse, brief case, etc. In alternative embodiments, the system 130 can be operated as a computing device in the closed state, with the microprocessor (not shown) causing only the first display screen 134 to display content. To this end, the system 130 can incorporate one or more sensors and/or user inputs by which the microprocessor can determine whether one or more than one of the display screens 134-140 are to be activated and caused to display content.

The housing 132 transitions to the opened state by rotating each of the frame portions 142-148 about the pin 152 (represented by an arrow in FIG. 5B). In the opened state, the display screens 134-140 are laterally spaced from one another, with each display screen 134-140 being at least partially, more preferably fully, exposed and thus viewable by a user (not shown). To this end, the housing 132 can further incorporate a locking mechanism (not shown) that selectively locks the frame portions 142-148 in the opened state of FIG. 5B. Regardless, as compared to the closed state of FIG. 5A, in the opened state, the display screens 134-140 combine to define a fan-like shape, providing an enlarged viewing area. For example, where the system includes the four display screens 134-140, the effective viewing area in the opened state is four times greater as compared to a single screen hand-held, mobile computing device.

During use, and similar to the embodiment of FIG. 4, the frame portions 142-148 are deployed to the opened state, thus exposing the display screens 134-140. The microprocessor (not shown) operates to coordinate displays on the display screens 134-140. For example, the microprocessor can cause a relatively continuous image to appear “across” the display screens 134-140 (e.g., a desired image can be divided into four segments, with the display screens 134-140 being prompted to display a respective one of the four segments). Alternatively, the display screens 134-140 can be prompted to display different yet related content (e.g., four separate spreadsheets relating to the same topic). Regardless, the system 130 can further include additional and/or differently shaped display screen(s)/frame portion(s), or can include only two or three of the display screens/frame portions.

In other embodiments, each of the frame portions 142-148 further maintain a microphone (not shown), respectively, each electronically connected to the microprocessor (not shown). In the opened state, each of the microphones are available to received audio input from a user(s). Under these circumstances, and similar to the coordinated display described above, the microprocessor operates to coordinate the audio inputs received by the microphones (for example to perform a noise cancellation operation). In a related alternative embodiment, each of the frame portions 142-148 further maintains a speaker (not shown), respectively, each electronically connected to the microprocessor. In the opened state, each of the speakers are available to deliver an audio output to a user(s). The microprocessor operates to coordinate the audio outputs delivered through the speakers (for example to create an enhanced audio presentation).

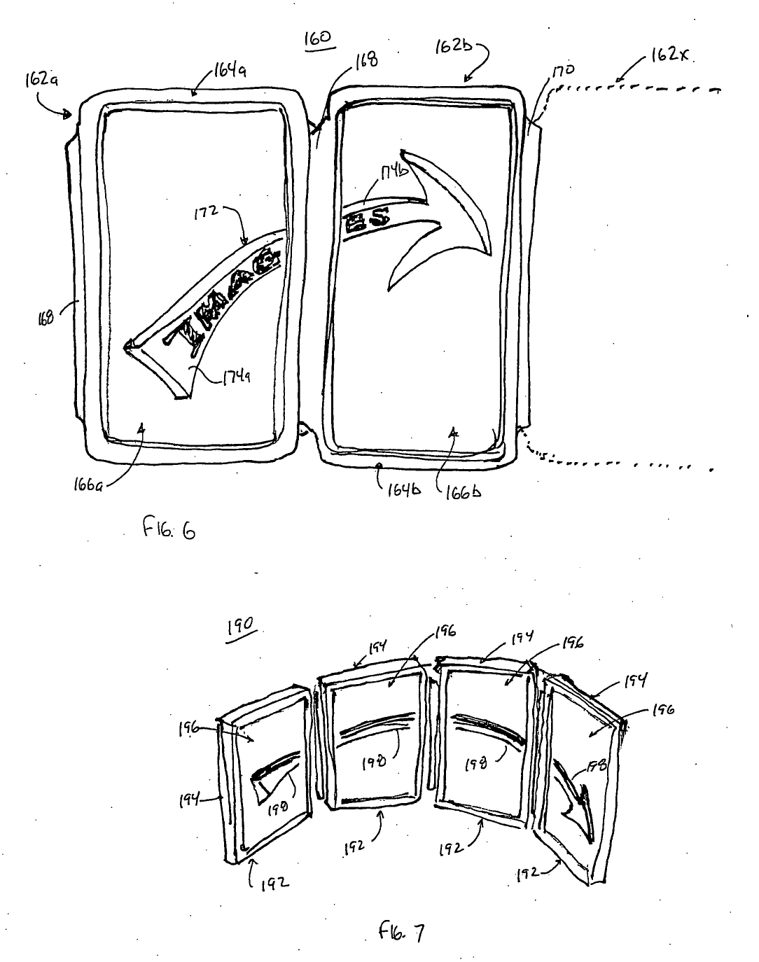

Yet another alternative embodiment hand-held, mobile computing system 160 is shown in FIG. 6 and includes at least first and second hand-held, mobile computing device 162a, 162b. The mobile computing devices 162a, 162b are provided separately from one another, such that they can be used independently (such as by two different users). In a shared display mode described below, however, the mobile computing devices 162a, 162b are linked, such that the system 160 can generate an enhanced content display.

The mobile computing devices 162a, 162b are, in one embodiment, identical, each including a housing 164a, 164b, a microprocessor (not shown), a display screen 166a, 166b, and a power source (not shown). The housing 164a and 164b is sized and shaped to be handled by a user's hand(s) (not shown), such that each of the mobile computing devices 162, 162b is highly portable. In addition, each of the housings 164a, 164b defines at least one, preferably two, connector ports 168, 170 (shown best for the second mobile computing device 162b in FIG. 6). The connector port(s) 168 and/or 170 can assume a wide variety of forms. For example, in one embodiment, the connector port 168 defines a male connector whereas the connector port 170 defines a female connector. With this configuration, the male connector port 168 of the first mobile computing device 162a is readily inserted, and thus connected to, the female connector port 170 of the second mobile computing device 162b, thus establishing a physical connection between the housings 164a, 164b. In addition, each connector port 168,170 contains or includes electrical connectors (not shown) that establish a communicative link between the microprocessors (not shown) of the mobile computing devices 162a, 162b upon final assembly. In one alternative embodiment, the connector ports 168/170 are configured to establish a hinged relationship between the housings 164a, 164b. With this embodiment, the system 160 can readily transition to an orientation akin to the orientation of FIG. 2B. Along these same lines and with this embodiment, one or both of the microprocessors can be adapted to perform a speech recognition or language translation operation as described with respect to the system 60 (FIG. 3). Even further, one or both of the microprocessors can be a multicore microprocessor, such that two-way language translation is available.

In an alternative embodiment, the connector port(s) 168 and/or 170 can be adapted to establish or facilitate a wireless or magnetic communicative link between the microprocessors (not shown), such that the respective housings 164a, 164b need not be physically connected. Regardless, once a communicative link between the respective microprocessors has been established, the system 160 can be operated to provide an enhanced display content on the display screens 166a, 166b.

As mentioned above, the respective microprocessors (not shown) are capable of operating the corresponding mobile computing device 162a and 162b as a standalone computing device. In addition, and in one embodiment, the microprocessor (not shown) of the first mobile computing device 162a and the microprocessor (not shown) of the second mobile computing device 162b are both adapted to operate in a shared display mode once the communicative link has been established. Alternatively, only one of the microprocessors can operate to dictate the displayed content on the display screens 166a, 166b in the shared display mode via the display driver of one or both of the devices 162, 162b. Regardless, in the shared display mode, the microprocessor(s) operate to prompt the display screens 166a, 166b to display correlated content. For example, as shown in FIG. 6, a desired image 172 can be divided into two segments 174a, 174b. The display screens 166a, 166b are prompted such that the first segment 174a is displayed on the first display screen 166a and the second segment 174b is displayed on the second display screen 166b, resulting in a relatively continuous image “across” the display screens 166a, 166b. Alternatively or in addition, the microprocessor(s) can operate to prompt the display screens 166a, 166b to display discrete, yet related content (e.g., two different web pages from a desired website), especially where one or both of the microprocessors is a multicore microprocessor. As shown in FIG. 6, the housings 164a, 164b are, in one embodiment, configured to arrange the display screens 166a, 166b in a substantially co-planar fashion, producing a relatively flat overall appearance when the devices 162a, 162b are linked. Importantly, however, where a wireless link is provided, the housings 164a, 164b are not physically connected, such that a multiplicity of different display screen arrangements can be achieved.

By providing each of the housings 164a, 164b with the male and female connector ports 168, 170, communicative links can be established via opposing sides of each mobile computing device 162a, 162b. Thus, while the system 160 has been described as including two of the mobile computing devices 162a, 162b, three or more of such devices can be linked in series (shown with dashed lines as 162x in FIG. 6). To this end, at least one, preferably all, of the microprocessors (not shown) associated with the linked mobile computing devices 162a, 162b, . . . 162x are adapted to determine the number of linked mobile computing devices, and adjust the displayed content shown on the display screens 166a, 166b accordingly (e.g., where it is determined that four of the mobile computing devices 162a, 162b have been linked, one or all of the microprocessors will divide a desired image into four segments and prompt the display screens to display a corresponding one of the segments). For example, the system 160 can include software with one or more of the mobile computing devices 162a, 162b, . . . 162x that constantly or intermittently performs a polling operation to determine the number of linked devices. Alternatively or in addition, the devices 162a, 162b, . . . , 162x can be adapted to immediately notify other devices of its presence upon being communicatively linked. Alternatively or in addition, the devices 162a, 162b, . . . , 162x can include a proximity sensor or strength of wireless signal sensor that provides information directly indicative of the presence of another, similarly configured device, causing the associated microprocessors to operate in the shared display mode. Alternatively or in addition, a user input can be provided by which a user can designate the number of linked devices.

In other embodiments, each of the mobile computing devices 162a, 162b further include a microphone (not shown) electronically connected to the respective microprocessor (not shown). When the devices 162a, 162b are communicatively linked, each of the microphones are available to received audio input from a user(s). Under these circumstances, and similar to the coordinated display described above, one or both of the microprocessors operate to coordinate the audio inputs received by the microphones (for example to perform a noise cancellation operation). In a related alternative embodiment, each of the mobile computing devices 162a, 162b further includes a speaker (not shown) electronically connected to the respective microprocessor. When communicatively linked, one or both of the microprocessors operate to coordinate the audio outputs delivered through the speakers (for example to create an enhanced audio presentation).

Yet another alternative embodiment hand-held, mobile computing system 190 is shown in FIG. 7. The system 190 is highly similar to the system 160 (FIG. 6) previously described, and includes two or more hand-held, mobile computing devices 192. Four of the mobile computing devices 192 are shown in FIG. 7, it being understood that a greater or lesser number (as few as two) can be provided. Each of the mobile computing devices 192 are capable of operating as a standalone, mobile computing device via a respective microprocessor (not shown), and each includes a housing 194 maintaining a display screen 196. As compared to the system 160 of FIG. 6, the housings 194 of the system 190 of FIG. 7 are adapted to arrange the display screens 196 in a curved fashion when connected or linked to one another, thus creating a panoramic-like shared display. Once again, and in one embodiment, in the shared display mode, the display screens 196 are prompted to display a relatively continuous image 198 “across” the display screens. Further, the devices 192 can alternatively be configured to provide a wireless, communicative link between the respective processors, such that the housings 194 need not be physically connected to achieve the shared display mode of operation. In addition, where one or more of the microprocessors is a multicore microprocessor, different content can be displayed on the various display screens 196. For example, two of the display screens 196 could be driven to display an identical spreadsheet, whereas the other two display screens 196 could be driven to display the same image (or a continuous image across the two display screens 196). A variety of other multiple, mobile display activities could also be performed.

Although the present invention has been described with reference to preferred embodiments, workers skilled in the art will recognize that changes can be made in form and detail without departing from the spirit and scope of the present invention.

1. A hand-held, mobile computing system for displaying content, the system comprising:
a first display screen;
a second display screen, wherein the first and second display screens are movable relative to one another;
a first microprocessor communicatively linked to the first and second display screens, wherein the microprocessor is adapted to prompt display of desired content on the first and second display screens such that content displayed on the first display screen correlates with content displayed on the second display screen; and
a first housing maintaining the microprocessor and physically connected to at least one of the first and second display screens, wherein the housing is sized to fit within a user's hands.

2. The system of claim 1, wherein the housing includes a first frame portion maintaining the first display screen and a second frame portion maintaining the second display screen, and further wherein the first and second frame portions are physically connected to one another such that the first frame portion is movable relative to the second frame portion.

3. The system of claim 2, wherein the housing further includes a connector hingedly connecting the first and second frame portions such that the housing is configured to provide a closed state in which the display screens are adjacent to and face one another, and an opened state in which the first frame portion is pivoted away from the second frame portion whereby the display screens are exposed and face in different directions.

4. The system of claim 3, wherein the microprocessor is further adapted to prompt display a first content on the first display screen and a second content on the second display screen when the housing is in the opened state, the first content including information in a first language and the second content including the information in a second language.

5. The system of claim 2, wherein the housing further includes a connector slidably connecting the first and second frame portions such that the housing is configured to provide a closed state in which the second display screen is substantially aligned with the first display screen, and an opened state in which the second display screen is laterally displaced from the first display screen such that the first and second display screens are exposed.

6. The system of claim 5, further comprising:
a third display screen maintained by a third frame portion of the housing, the third frame portion being slidably connected to a least one of the first and second frame portions such that in the closed state, the third screen is substantially aligned with the first and second display screens, and in the opened state, the third display screen is laterally displaced from, and exposed relative to, the first and second display screens.

7. The system of claim 2, wherein the housing further includes a connector rotatably connecting the first frame portion and the second frame portion adjacent corresponding perimeter areas thereof such that the housing is configured to provide a closed state in which the second display screen is aligned with the first display screen, and an opened state in which the second display screen is rotated relative to a position in the closed state and the first and second display screens are both exposed.

8. The system of claim 7, further comprising:
a third display screen maintained by a third frame portion of the housing, the third frame portion being rotatably connected to at least one of the first and second frame portions adjacent a corresponding perimeter area thereof such that in the closed state, the third display screen is substantially aligned with the first and second display screens, and in the open state, the third display screen is exposed and combines with the first and second display screens to form a fan-like shape.

9. The system of claim 1, wherein the first display screen and the first microprocessor are maintained by the first housing, the system further comprising:
a second housing provided apart from the first housing, the second housing maintaining the second display screen; and
a second microprocessor maintained by the second housing and electronically connected to the second display screen;
wherein the first and second housings are adapted to selectively establish a communicative link between the first and second microprocessors;
and further wherein at least one of the first and second microprocessors is further adapted to:
prompt a correlated display on the first and second display screens when the first and second microprocessors are linked.

10. The system of claim 9, wherein the correlated display includes a display on the second display screen visually appearing as a continuation of a display on the first display screen.

11. The system of claim 9, wherein the first housing, microprocessor, and display screen comprise at least a portion of a first hand-held, mobile computing device and the second housing, microprocessor, and display screen comprise at least a portion of a second hand-held mobile computing device.

12. The system of claim 9, wherein the first and second housings are configured to selectively, physically mate to one another.

13. The system of claim 9, further comprising:
a third housing provided apart from the first and second housings;
a third display screen maintained by the third housing; and
a third microprocessor maintained by the third housing and electronically connected to the third display screen;
wherein the third housing is adapted to selectively establish a communicative link between the third microprocessor and at least one of the first and second microprocessors; and
further wherein at least one of the first, second, and third microprocessors is further adapted to:
prompt a correlated display on the first, second, and third display screens when the first, second, and third microprocessors are linked.

14. The system of claim 13, wherein at least one of the first, second, and third microprocessors is further adapted to recognize a number of linked display screens.

15. The system of claim 9, wherein at least one of the first and second microprocessors is further adapted to:
operate in a shared display mode upon recognizing that the first and second housings have been connected to one another.

16. The system of claim 9, further comprising:
a first microphone maintained by the first housing and electronically connected to the first microprocessor;
a second microphone maintained by the second housing and electronically connected to the second microprocessor;
wherein at least one of the first and second microprocessors is further adapted to coordinate audio inputs received at the first and second microphones.

17. The system of claim 9, further comprising:
a first speaker maintained by the first housing and electronically connected to the first microprocessor; and
a second speaker maintained by the second housing and electronically connected to the second microprocessor;
wherein at least one of the first and second microprocessors is further adapted to coordinate audio outputs delivered through the first and second speakers.
